(19) United States
(12) Patent Application Publication
(10) Pub. No.: US 2025/0362944 A1
(43) Pub. Date: Nov. 27, 2025

(54) SYSTEM AND METHOD FOR ANALYZING CONTEXTUAL DATA OF A USER INTERFACE

(71) Applicant: Walmart Apollo, LLC, Bentonville, AR (US)

(72) Inventors: Sareena Khera, San Diego, CA (US); Sriprabha Gopalan, Bangalore (IN); Sreekanth Suruvu, Andhra Pradesh (IN); Benjamin Valentine Leiker, West Boylston, MA (US); Shani Haviva Abada, White Plains, NY (US); Robert Kyle Sosin, New York, NY (US); Yannell Rodriguez, Bloomfield, NJ (US); David James Kendall, Bristol, CT (US); Qinwei Zhu, Seattle, WA (US); Tarang Agarwal, Delhi (IN)

(21) Appl. No.: 19/213,823

(22) Filed: May 20, 2025

Related U.S. Application Data
(60) Provisional application No. 63/650,192, filed on May 21, 2024.

(51) Int. Cl. G06F 9/451; G06F 40/30

(52) U.S. Cl. CPC G06F 9/453; G06F 40/30

(57) ABSTRACT

System and methods for analyzing contextual data of a user interface are disclosed. In some embodiments, a disclosed method includes: storing, in a database, historical customer data associated with a customer, receiving, from a user interface, an indication of a customer's interaction with a digital assistant and a webpage, receiving, using the digital assistant, a prompt from the customer, the prompt being in one or more of an audio format or a graphical format, parsing and extracting intent data from the prompt based on the historical customer data and contextual data from a webpage, and executing a task based on the intent data, the task associated with the customer's interaction with the webpage and the digital assistant.

### REFERENCE TO RELATED APPLICATIONS

This application claims the benefit of and priority to U.S. Provisional Patent Application No. 63/650,192, filed May 21, 2024, the entire disclosure of which is hereby incorporated by reference.

### TECHNICAL FIELD

This application relates generally to analyzing contextual data of a user interface and, more particularly, to systems and methods for analyzing contextual data of a user interface using a natural language processor.

### BACKGROUND

Voice activated digital assistants (“digital assistants”) are becoming more prevalent in our everyday lives. Retailers use digital assistants to streamline actions that a customer can take to navigate their e-commerce platform. However, many digital assistants rely on voice or text prompts without taking into account contextual data or data presented on the webpage.

### SUMMARY

The embodiments described herein are directed to systems and methods for generating cohesive product recommendation sets and variants.

In various embodiments, a system including a database storing historical customer data associated with a customer, a computing device comprising at least one processor in communication with the database, the computing device being configured to receive, from a user interface, an indication of a customer's interaction with a digital assistant and a webpage, receive, using the digital assistant, a prompt from the customer, the prompt being in one or more of an audio format or a graphical format, parse and extract intent data from the prompt based on the historical customer data and contextual data from a webpage, and execute a task based on the intent data, the task associated with the customer's interaction with the webpage and the digital assistant.

In various embodiments, a computer-implemented method is disclosed. The computer-implemented method includes storing, in a database, historical customer data associated with a customer, receiving, from a user interface, an indication of a customer's interaction with a digital assistant and a webpage, receiving, using the digital assistant, a prompt from the customer, the prompt being in one or more of an audio format or a graphical format, parsing and extracting intent data from the prompt based on the historical customer data and contextual data from a webpage, and executing a task based on the intent data, the task associated with the customer's interaction with the webpage and the digital assistant.

In various embodiments, a non-transitory computer readable medium having instructions stored thereon is disclosed. The instructions, when executed by at least one processor, cause at least one device to perform operations including: storing, in a database, historical customer data associated with a customer, receiving, from a user interface, an indication of a customer's interaction with a digital assistant and a webpage, receiving, using the digital assistant, a prompt from the customer, the prompt being in one or more of an audio format or a graphical format, parsing and extracting intent data from the prompt based on the historical customer data and contextual data from a webpage, and executing a task based on the intent data, the task associated with the customer's interaction with the webpage and the digital assistant.

### BRIEF DESCRIPTION OF THE DRAWINGS

The features and advantages of embodiments of the present application will be more fully disclosed in, or rendered obvious by the following detailed description of the preferred embodiments, which are to be considered together with the accompanying drawings wherein like numbers refer to like parts and further wherein:

FIG. 1 is a network environment configured to analyze contextual data of a user interface, in accordance with some embodiments of the present teaching.

FIG. 2 is a block diagram of a contextual data analyzer, in accordance with some embodiments of the present teaching.

FIG. 3 is a flow diagram of a system for analyzing contextual data, in accordance with some embodiments of the present teaching.

FIG. 4 is a flow diagram of an exemplary model for analyzing context data by the system of FIG. 3, in accordance with some embodiments of the present teaching.

FIG. 5 is a flow diagram of a recommendation engine of the system for generating variant cohesive sets, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for analyzing contextual data of a webpage. In some embodiments, the systems and methods utilize models (e.g., machine learning models) to analyze contextual data. For example, the systems and method provided herein may analyze contextual data of a webpage and use one or more models to provide responses to a user. The contextual data may be used with a digital assistant (e.g., in a mobile application or webpage) to allow a user to navigate a webpage and/or perform tasks. In some embodiments, the systems and methods provided herein allow a user to perform tasks using a digital assistants that they would have had to do manually.

In some embodiments, the systems and methods for analyzing contextual data of a webpage include using a digital assistant. For example, a user may initiate a digital assistant using an electronic device (e.g., a mobile device). The digital assistant may receive voice prompts and text prompts as inputs and may output audio information, textual data, graphical data, or may complete a task or action. In some embodiments, the digital assistant is configured to perform actions through a webpage of a retailer. For example, a user may use a digital assistant, via a mobile application or webpage, to add one or more items to a cart of a retailer's e-commerce platform. The digital assistant may analyze contextual data of a webpage being displayed on a user interface to determine the desired actions of a user based on an input prompt (e.g., audio and/or text prompt).

One goal of the present teaching is to analyze contextual data of a webpage or display of a user interface. In some embodiments, a disclosed system utilizes one or more models to provide a response to a user's prompt. For example, the disclosed system may use one or more models to perform a task based on a user's prompt. In some embodiments, the disclosed system includes a digital assistant configured to perform tasks based on a user's prompt.

In some embodiments, the system includes a user interface configured to display a webpage associated with a retailer. The webpage may include contextual data configured to be analyzed by one or more models to determine a desired task of a user based on a user's prompt. For example, a user may activate a digital assistant on a webpage by interacting with an icon or graphic on the user interface. The user may provide an audio or text prompt to the digital assistant. The digital assistant may utilize one or more models to perform a task and/or provide a response to the user in response to the prompt by the user. In some embodiments, the digital assistant provides an audio and/or graphical output in response to the user's prompt. The digital assistant may perform an action on the user interface based on the user's prompt.

Furthermore, in the following, various embodiments are described with respect to methods and systems for analyzing contextual data. In some embodiments, a disclosed method includes: storing, in a database, historical customer data associated with a customer, receiving, from a user interface, an indication of a customer's interaction with a digital assistant and a webpage, receiving, using the digital assistant, a prompt from the customer, the prompt being in one or more of an audio format or a graphical format, parsing and extracting intent data from the prompt based on the historical customer data and contextual data from a webpage, and executing a task based on the intent data, the task associated with the customer's interaction with the webpage and the digital assistant.

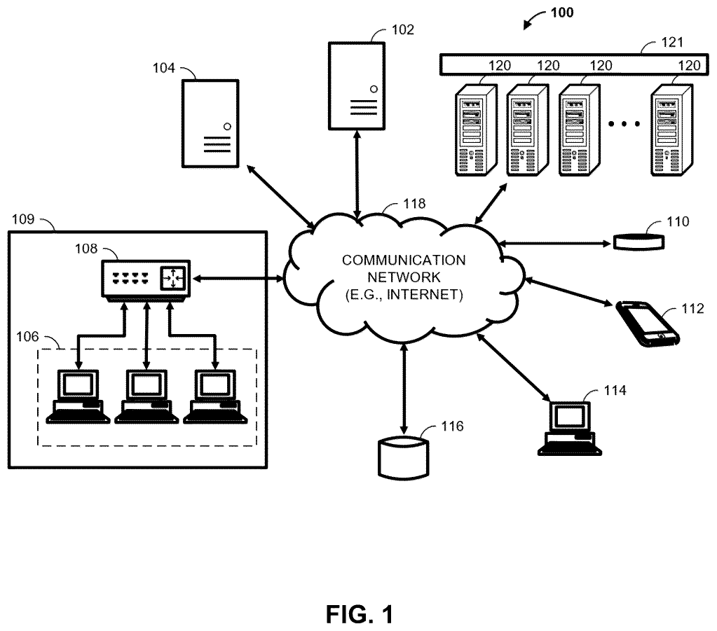

Turning to the drawings, FIG. 1 is a network environment 100 configured to analyze contextual data presented on a user interface, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, contextual data analyzer (“analyzer”) 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The analyzer 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the analyzer 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the analyzer 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the analyzer 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider). In some embodiments, analyzer 102 is configured to communicate with a digital assistant (e.g., digital assistant 250). Digital assistant 250 may be implemented into a mobile device and accessed via user interface 205.

The workstation(s) 106 are operably coupled to the communication network 118 via a router (or switch) 108. The workstation(s) 106 and/or the router 108 may be located at a store 109 of a retailer, for example. The workstation(s) 106 can communicate with the analyzer 102 over the communication network 118. The workstation(s) 106 may send data to, and receive data from, the analyzer 102. For example, the workstation(s) 106 may transmit data identifying items purchased by a customer at the store 109 to the analyzer 102.

Although FIG. 1 illustrates three user computing devices 110, 112, 114, the network environment 100 can include any number of user computing devices 110, 112, 114. Similarly, the network environment 100 can include any number of the analyzer 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view a user interface for viewing and interacting with the website or webpage of a retailer. The website may allow a user to view, interact with, and/or purchase items. Analyzer 102 may allow a user to input prompts, such as via a digital assistant (e.g., digital assistant 250), and may perform a task in response to the inputted prompt. The digital assistant (e.g., digital assistant 250) may be accessed via a mobile application and/or a webpage. The task may be associated with one or more items presented on the website. In some embodiments, the website captures these activities as user session data, and transmit the user session data to the analyzer 102 over the communication network 118.

In some examples, a user (e.g., a customer) may use one of the user computing devices 110, 112, 114 to view one or more products hosted by a website of a retailer. The customer may use analyzer 102 to interact with products on the website. The user may use a user interface to view and purchase products via web server 104. The user may, via the web browser or the user interface, view and interact with one or more products or items. The website may capture at least some of these activities as user data. The web server 104 may transmit the user data to the analyzer 102 over the communication network 118, and/or store the user data to the database 116.

In some embodiments, the web server 104 transmits a request to the analyzer 102, e.g. based on a customer's interaction. For example, the request may be sent based on a user providing an input, such as a prompt, into digital assistant 250. The prompt may be audio or graphical (e.g., images, text, video). The request may be sent standalone or together with other related data of the website. In some examples, the request may carry or indicate user data.

In some examples, the analyzer 102 may execute one or more models (e.g., algorithms), such as a mathematical models, machine learning model, deep learning model, statistical model, etc., to provide an output to the user. The output may be presented on the user interface and/or may include a performed task. The analyzer 102 may perform a task via the user interface, such as adding one or more items to a cart, changing a preference, interacting with one or more items of the website, and/or selecting one or more items for purchase.

The analyzer 102 is further operable to communicate with the database 116 over the communication network 118. For example, the analyzer 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the analyzer 102, in some examples, the database 116 can be a local storage device, such as a hard drive, a non-volatile memory, or a USB stick. The analyzer 102 may store historical data, business metrics, user data, or data associated with one or more products received from the web server 104 in the database 116. The analyzer 102 may receive customer data (e.g., customer historical data). The analyzer 102 may also receive from the web server 104 user session data identifying events associated with browsing sessions, and may store the user session data in the database 116. Database 116 may be coupled to a computing device. For example, database 116 may be coupled to one or more user computing devices 110, 112, 114 via communication network 118.

In some embodiments, the web server 104 transmits a model training request to the analyzer 102. Upon the model training request, the analyzer 102 may retrieve, e.g. from the database 116, historical data associated browsing history of a customer. The analyzer 102 may train one or more models using the historical data of the customer. The one or more models may be trained to generate outputs for analyzer 102. The one or more models may be trained to generate outputs for analyzer 102 based on an input (e.g., prompt) from a user. In some embodiments, the one or more models are configured to receive feedback from the customer to refine or retrain the one or more models. For example, a customer may input a prompt into analyzer 102 via digital assistant 250. Analyzer 102 may cause a user interface to display an item. The customer may input a subsequent prompt into analyzer 102 via digital assistant 250 indicating that the item is not what the customer desires or is looking for. Analyzer 102 may present another item and may refine one or more models based on the subsequent prompt of the customer.

In some embodiments, the outputs from the model may be used to refine and train the model. For example, one or more models may be trained using historical data (e.g., historical transaction data of the customer) and may generate a plurality of recommended products the customer may desire. Analyzer 102 may receive purchase data associated with whether the customer purchased one or more items in the past. The purchase data, including the purchased products, may be inputted into the one or more models such that the one or more models compares the purchased products to the recommended products to generate a comparison value. The greater the comparison value the greater the deviation the purchased product is from the recommended products. In other words, the greater the comparison value, the less accurate the one or more models are. In some embodiments, the comparison value may be inputted into the one or more models to refine the one or more models to make the one or more models more accurate. In some embodiments, the one or more models used by analyzer 102 are language models. The language models may receive linguistic data (e.g., speech of the customer/user) and match the linguistic data with the closest data associated with the customer's history data.

The models, when executed by the analyzer 102, allow the analyzer 102 to generate a plurality of recommended products for display to the customer and/or perform one or more tasks. In some examples, the analyzer 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the analyzer 102 may perform one or more tasks and/or present one or more products to the customer that the customer desires.

In some embodiments, analyzer 102 is configured to analyze the contextual data presented on a webpage. For example, a customer may input a prompt into analyzer 102 via digital assistant 250. Analyzer 102 may provide an output (e.g., a response) based on the prompt and analyzing the webpage that the customer is currently interacting with or viewing. Based on the webpage and the prompt, analyzer 102 may perform a specific task and/or provide one or more items for the customer to interact with (e.g., view, add to cart, or purchase).

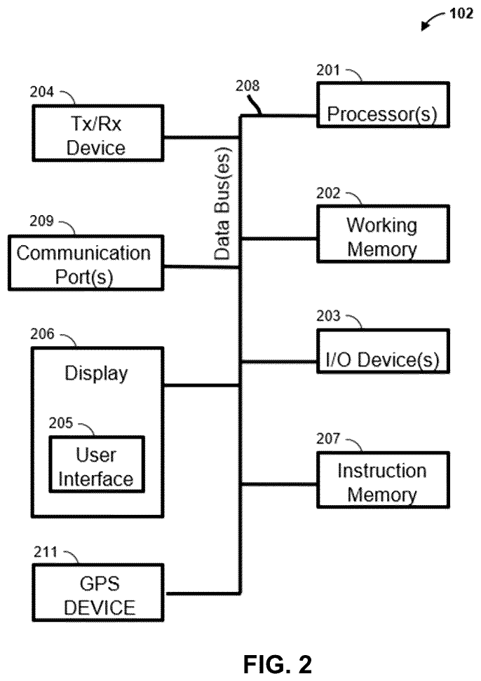

FIG. 2 illustrates a block diagram of a contextual data analyzer, e.g. the analyzer 102 of FIG. 1, in accordance with some embodiments of the present teaching. In some embodiments, each of the analyzer 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the analyzer 102 can be combined, omitted, and/or replicated. In addition, it will be appreciated that additional elements other than those illustrated in FIG. 2 can be added to the analyzer 102.

As shown in FIG. 2, the analyzer 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the analyzer 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the analyzer 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the analyzer 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the analyzer 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the analyzer 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the analyzer 102 and/or the web server 104. For example, the user interface 205 can be a user interface for an application of a network environment operator that allows a customer to view and interact with the plurality of items presented by the analyzer 102. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the analyzer 102 may determine a local geographical area (e.g., town, city, state, etc.) of its position.

In some embodiments, the analyzer 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the analyzer 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data may include historical data of customers. Further, the training data includes historic sales data (e.g., of the recommended products), typically for one or more years, in association with historic inventory information, historic marketing information, and other such information. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems is configured to receive feedback information at least through the graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained models to provide more accurate recommended products and prioritization of the recommended products to the customer. This allows the models to be refined per customer to provide recommended products that the customer has a high likelihood of purchasing.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information through the graphical user interface corresponding to actions by the recipient interfacing with the graphical user interface.

The above and below description includes descriptions of embodiments implementing and/or utilizing trained machine learning models and/or neural networks. For example, the systems and methods described herein may utilize one or more natural language processing (NLP) models to process spoken language. In some embodiments, the neural network, machine learning models and/or machine learning algorithms may include, but are not limited to, Large Language Models (LLM), Heuristics, Univariate based techniques, Multivariate, control limit, isolation forest and LOF—ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

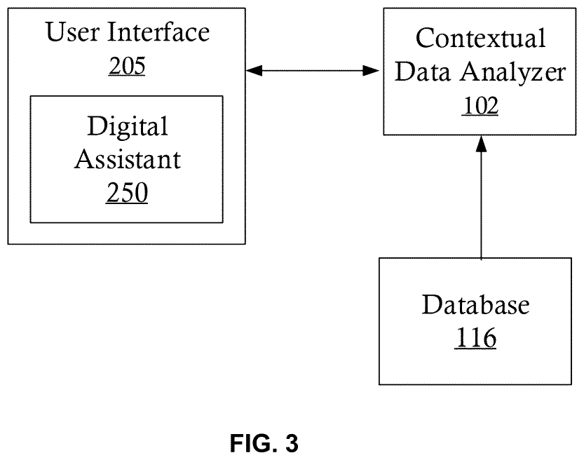

FIG. 3 is a flow diagram showing a method of using analyzer 102, in accordance with some embodiments of the present teaching. As indicated in FIG. 3, analyzer 102 may be configured to communicate with user interface 205 and database 116. Analyzer 102 may be configured to receive and transmit data, such as customer data and/or historical customer data, to database 116. In some embodiments, a customer accesses analyzer 102 via user interface 205. For example, a customer may interact with digital assistant 250 via user interface 205 and may provide an input or prompt to digital assistant 250. Digital assistant 250 may be implemented on a computer device (e.g., computing device 110, 112, or 114) and may transmit the prompt analyzer 102. Analyzer 102 may receive the input or prompt and, using one or more models, may perform a task such as presenting one or more items for viewing on user interface 205, navigating to a different webpage, or adding one or more items to a cart or list.

In some embodiments, analyzer 102 analyzes contextual data. The contextual data may be data presented on the webpage. The contextual data may include data and information presented on the webpage to the customer. The contextual data may include one or more items and/or tasks that the customer can perform based on the specific webpage. For example, a webpage may include an add to cart button that a customer can use to add an item to cart. A customer may prompt analyzer 102 via digital assistant 250 to purchase an item. Analyzer 102 may determine, based on the contextual data of the webpage, that there is an option for the customer to add an item to a cart and thus may, without human intervention, add the item to the cart for purchasing.

In some embodiments, analyzer 102 receives requests via digital assistant 250. Digital assistant 250 may be present on user interface 205 while the customer navigates a website or one or more webpages of a retailer. Digital assistant 250 may be configured to receive audio or graphical prompts. In some embodiments, digital assistant 250 is configured to activated based on a wake-up word. For example, the customer, when navigating one or more webpages of the retailer, may use the wake-up word and then provide an audio input. Digital assistant 250 may be in communication with analyzer 102 and may transmit the input to analyzer 102. Analyzer 102 may perform one or more tasks based on the input. In some embodiments, digital assistant 250 is in constant communication with analyzer 102. Digital assistant 250 may be accessed via user interface 205 and may always be in a ready-state to receive an input or prompt from a user.

Digital assistant 250 being the ready-state allows analyzer 102 to receive prompts without any human intervention. For example, a user may utilize a wake-up word for digital assistant 250 and may provide a prompt. The prompt may be automatically transmitted to analyzer 102, which is configured to, without human intervention, generate an output based on the prompt. The analyzer 102 may receive the prompt and analyze the contextual data of the webpage the customer was interacting with at the time of providing the input/prompt. The contextual data of the webpage may be used by analyzer 102 to generate an output. For example, analyzer 102 may input the contextual data and the input/prompt into one or more models (e.g., an NLP model) to generate an output. The output may be a desired task that the customer wants to perform. Analyzer 102 may perform the task without the customer having to manually intervene.

In some embodiments, a customer may use analyzer 102 to search for a product on a retailer's website. For example, the customer may provide a prompt to digital assistant requesting one or more items. The request may be transmitted from digital assistant 250, accessed via user interface 205, to analyzer 102. Analyzer 102 may parse the request and generate an output based on the prompt. Analyzer 102 may then cause user interface 205 to display the output (e.g., one or more desired items) in response to the request.

A customer may communicate with digital assistant 250 to cause analyzer 102 to search/filter items provided by a retailer via their website, navigate to one or more webpages of the website, manage a cart of the website, add one or more items to a cart, place an order for item, or reorder a previously ordered item. For example, a customer may prompt digital assistant 250 to reorder an item. Digital assistant may transmit the request to analyzer 102, which using one or more models, may analyze prior transaction history of the customer. Analyzer 102 may identify the most recent order and add those items to cart of the website to allow the customer to purchase the items. In some embodiment, analyzer 102 automatically purchases the items of the most recent order. Analyzer 102 may be configured to cause digital assistant 250, via user interface 205, to provide an audio or graphical response of what task was completed.

In some embodiments, analyzer 102 utilizes one or more intent based models. The one or more intent based models may be trained using the customer's historical transaction data. In some embodiments, each customer has their intent based models trained based on their specific historical transaction data. In some embodiments, analyzer 102 receives prompt data from digital assistant 250. Analyzer 102 may parse and extract intent data (e.g., inferred intent) from the prompt data to determine the desired task of the customer. Analyzer 102 may perform a task based on the intent data.

In some embodiments, a customer uses informal language, which is parsed by analyzer 102. For example, a customer may prompt digital assistant 250 to “add my usual cereal to cart.” This prompt is transmitted to analyzer 102, which processes the prompt using one or more NLP models. Analyzer 102 may input the prompt and the customer's historical transaction data into one or more models and may generate an output. Based on the prompt in the above example, the output may be a specific cereal product that the customer has previously and frequently purchased. Analyzer 102 may transmit a purchase request to purchase the specific cereal brand have it shipped to the customer' address. Analyzer 102 may automatically pay for the item using a stored payment method associated with the customer.

In some embodiments, a customer uses digital assistant 250, via user interface 205, and analyzer 102 to perform one or more tasks. For example, a customer may prompt digital assistant 250 to perform a task. The prompt may be transmitted to analyzer 102, which parses the prompt using one or more models (e.g., one or more NLP models) to determine the desired task of the customer. Analyzer 102 may then perform the task and cause user interface 205 to show an indication of the completed task. In practice, a customer may prompt digital assistant 250 to book a delivery. The prompt may be transmitted to analyzer 102, which parses the prompt and identifies that the customer has one or more items in a cart. Analyzer 102 may attempt to schedule a delivery and transmit a request to the customer via digital assistant 250. Digital assistant 250 may prompt the customer to provide a time, date, and/or location. Upon prompting the customer, digital assistant 250 may enter a listening mode to receive instructions from the customer without the customer having to wake-up or manually interact with digital assistant 250. Upon receiving the instructions from the customer in audio or graphical format, digital assistant 250 may transmit the instructions to analyzer 102, which completes the desired task and provides confirmation of the completed task to the customer via user interface 205.

In some embodiment, a customer interacts with digital assistant 250 using audio commands. A customer may interact with digital assistant 250 using graphical commands, such as inputting prompts using input-output device 203.

In some embodiments, a customer uses digital assistant 250 to provide information or updates. For example, a customer may prompt digital assistant 250 to identify the status of a delivery or location of a product in an order to be delivered. Digital assistant 250 may transmit the prompt to analyzer 102, which may submit a request to database 116 or an external database to determine the location or status of an order or product. Analyzer 102 may receive the location or status and cause digital assistant 250 and/or user interface 205 to display the location or status.

In some embodiments, analyzer 102 is configured to guide a customer through a task. For example, using user interface 205 and digital assistant 250, analyzer 102 may guide a customer through a desired task. A customer may prompt digital assistant 250 to “check out.” The prompt of “check out” may indicate the customer's desired to purchase items that are within a cart of the retailer's website that the customer is interacting with. In some embodiments, a user can prompt digital assistant 250 to “check out” regardless of the webpage that the customer is interacting with. Analyzer 102 may analyze the contextual data of the screen to determine which webpage the customer is currently interacting with. Analyzer 102 may cause user interface 205 to navigate to specific webpages to assist the customer in checking out. In some embodiments, analyzer 102 causes user interface 205 to navigate to specific webpages based on the customer's prompts.

In some embodiments, analyzer 102 analyzes the contextual data of a webpage that the customer is viewing and completes tasks based on the contextual data. For example, a customer may be viewing a webpage of a specific product and may prompt digital assistant 250 to “purchase this item” or similar language. Digital assistant 250 may transmit this prompt to analyzer 102, which parses the prompt using one or more models (e.g., one or more NLP models). Analyzer 102 may also receive, via user interface 205, the contextual data of the webpage the customer is viewing when the prompt was made. Analyzer 102 may parse the contextual data of the webpage and based on the parsed prompt, may identify that the customer desires to purchase the item being displayed on the webpage. Analyzer 102 may then purchase the specific item and cause user interface 205 to display confirmation of purchasing of the item. Further, analyzer 102 may cause digital assistant 250 to prompt the customer to identify whether the purchased product is for delivery or pick-up.

Analyzer 102 may use one or more models for natural language processing of audio prompts. In some embodiments, analyzer 102 uses one or more models to present items to the customer based on prompts. For example, analyzer 102 may use one or more models to parse the customer's historical transaction data to determine previously purchased items or determine recommend products. For example, analyzer 102 may use one or more models that uses the customer's historical transaction data as an input to output recommended products or products that the customer has a high likelihood of purchasing.

In some embodiments, a customer uses digital assistant 250 and analyzer 102 to perform one or more tasks discussed below. The below uses cases are not deemed exhaustive. In some embodiments, digital assistant 250 transmits each received prompt or input to analyzer 102, which parses the prompts. Analyzer 102 may use one or more models, such as one or more NLP models, to parse the prompts and generate a response (e.g., output) to be provided the customer. The output may be provided to the customer via digital assistant 250 and/or user interface 205. For example, analyzer 102 may cause digital assistant 250 and/or user interface 205 to provide the output as an audio response and/or a graphical response.

If a customer (without an open order) is on a specific webpage, such as an “Order Details” page, and provides an input (e.g., prompt) indicating they want to buy without mentioning a product, digital assistant 250 may transmit the prompt to analyzer 102, which parses the prompt and causes digital assistant 250 to confirm whether they want to add all items displayed in the order in view to their online shopping cart. If a customer (with an open order and items in their cart that could be added to the order) is on the “Order Details” page of an order that they cannot add to or modify and provides an input (e.g., prompt) indicating they want to buy without mentioning a specific product or item, digital assistant 250 may transmit the prompt to analyzer 102, which parses the prompt and causes digital assistant 250 confirm from the customer whether they want to add all items displayed in the order in view to their online shopping cart.

If a customer (with an open order and items in their cart that could be added to the order) is on the “Order Details” page of an order, that they can add to, and provides an input (e.g., prompt) indicating that they want to buy without mentioning a specific product from the order, digital assistant 250 may transmit the prompt to analyzer 102, which parses the prompt and cause digital assistant 250 confirm if they want to add everything in their cart to their nearest upcoming order. If a customer (with an open order and amendable items in their cart) on a “Search Results” page provides an input (e.g., prompt) indicating that they want to buy without a specific product or rank of the product on the page, digital assistant 250 may transmit the prompt to analyzer 102, which parses the prompt and causes digital assistant 250 confirm if they want to add everything in their cart to their nearest upcoming order. If a customer on an item page provides an input (e.g., prompt) indicating that they want to buy without stating a specific product, digital assistant 250 may transmit the prompt to analyzer 102, which parses the prompt and causes user interface 205 to show an indication of adding the item to their cart.

If a customer provides an input (e.g., prompt) indicating that they want to reorder a product or brand (or ask to order a product or brand) but only say part of the product name, digital assistant 250 and analyzer 102 will use the context of their order history to find the item they mean to order. If a customer provides an input (e.g., prompt) indicating that they want to reorder without stating a specific product while viewing an “Order Details” page of an order eligible for reorder, digital assistant 250 may transmit the prompt to analyzer 102, which parses the prompt and causes digital assistant 250 to confirm if the customer wants to add everything in the order to the cart. If the customer agrees, then analyzer 102 adds everything in the order to their cart, else analyzer 102 causes user interface 205 to navigate the customer to the page that displays previously purchased items.

If a customer is on the “My Items” page (displaying previously purchased items) and makes a product reorder request, and the reorder gets processed successfully, analyzer 102 will not cause user interface 205 to navigate the customer to the cart and instead keep the customer on the same page to continue basket building. If a customer is on any other page when they request reorder, analyzer 102 may cause user interface 205 to navigate the customer to the cart page.

If customer is on the cart page and asks to check out, analyzer 102 causes user interface 205 to navigate to the review order phase of checkout without going through the cart phase (where the customer normally receives a count and subtotal of items and are asked if they want to proceed with checkout). If customer is on the review order page and asks to check out, analyzer 102 may cause digital assistant 250 to prompt the customer if they want to check out.

If a customer with an open order is on the “Order Details” page of the open order and provides an input (e.g., prompt) indicating the need to amend order, digital assistant 250 may transmit the prompt to analyzer 102, which parses the prompt and causes digital assistant 250 to inform the customer this is where they can make changes and tells them how long their amend window is. If a customer with an open order is on the “Order Details” page of a closed order and provides an input (e.g., prompt) indicating the need to amend an order, analyzer 102 may cause user interface 205 to navigate to the “Order Details” page of the open order and informs the customer that they could not make changes in the older order but this order is where they can make changes and tells them how long their amend window is.

If a customer with more than one open order is on the “Order Details” page of a closed order and provides an input (e.g., prompt) indicating the need to amend order without stating order fulfilment type or its date/time, digital assistant 250 may transmit the prompt to analyzer 102, which parses the prompt and causes user interface 205 to navigate to the “Order Details” page of the open order that is to be fulfilled next and informs the customer that this order is where they can make changes and tells them how long their amend window is.

If a customer with more than one open order is on the “Order Details” page of a closed order and provides an input (e.g., prompt) indicating the need to amend order stating order fulfilment type or its date/time matching one of their open orders, digital assistant 250 may transmit the prompt to analyzer 102, which parses the prompt and causes digital assistant 250 to navigate to the “Order Details” page of the matching open order and informs the customer that this order is where they can make changes and tells them how long their amend window is

If a customer with greater than one open order is on the “Order Details” page of an open order that is not the next one to be fulfilled, and provides an input (e.g., prompt) indicating the need to amend order, digital assistant 250 may transmit the prompt to analyzer 102, which parses the prompt and causes user interface 205 to stay on that “Order Details” page and inform the customer that this order can be modified but no items can be added to it and tells the customer how long their amend window is.

If a customer with greater than one open order is on the “Order Details” page of an open order that is the next one to be fulfilled and provides an input (e.g., prompt) indicating the need to amend order, digital assistant 250 may transmit the prompt to analyzer 102, which parses the prompt and causes user interface 205 to navigate to the “Edit Items” webpage and informs the customer how long their amend window is.

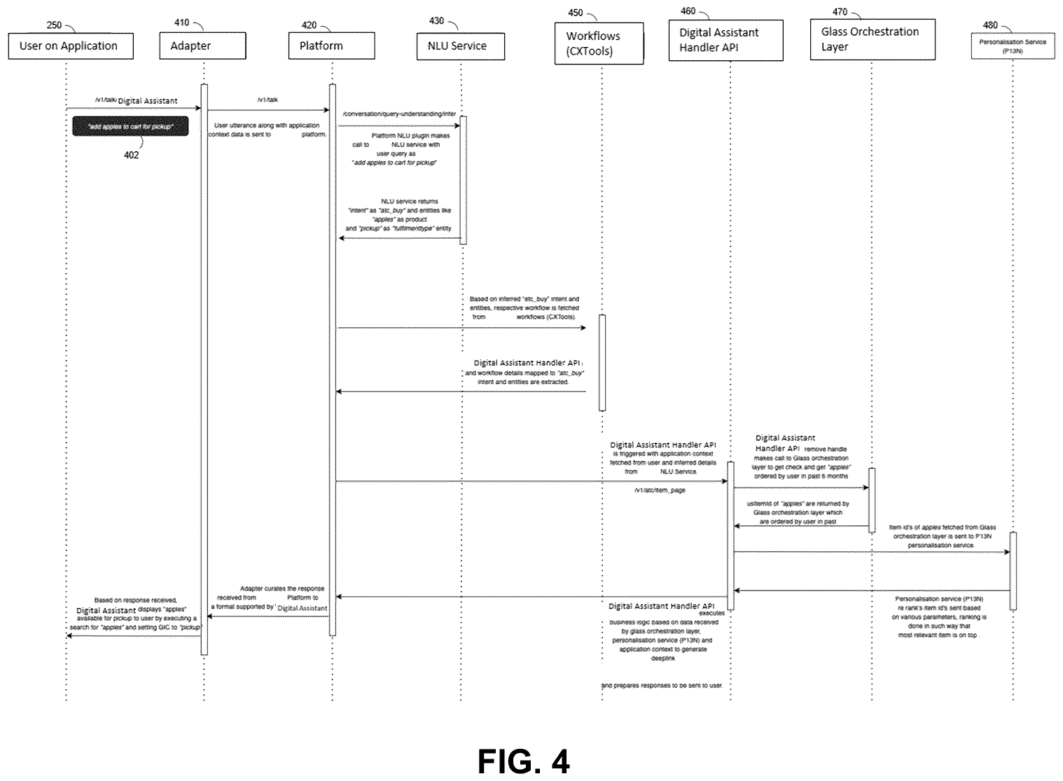

FIG. 4 is a swim diagram illustrating an exemplary method of analyzing contextual data, in accordance with some embodiments of the present teaching. Referring to FIG. 4, a customer using digital assistant 250 on user interface 205 may provide a prompt (e.g., prompt 402). Prompt 402 may be an audio or text input by the customer. Adapter 410 may receive prompt 402 and combine prompt 402 with contextual data of a webpage that the customer is interacting with. Adapter 410 may transmit prompt 402 and the contextual data to Platform 420. Platform 420 may make a call to NLU Service 430 with prompt 402. NLU Service 430 may be a natural language understanding/processing model. NLU Service 430 may be configured to provide real time inference of utterance (e.g., audio statements) provided by the customer and returns inferred “intent” (goal/task) and “entities” (details relevant to the goal/task) such that Platform 420 can understand and invoke correct workflow based on intent and entities received.

NLU Service 430 may return an intent based on prompt 402. For example, prompt 402 may be parsed using analyzer 102 (and one or more models) to determine the intent of prompt 402. By way of an example, prompt 402 may include an audio input from the customer saying, “add apples to cart for pickup.” NLU Service 430 may determine the intent of the prompt as being an intent to add apples to a cart (command: atc_buy) and assign a fulfillmentype as “pickup.”

NLU Service 430 may transmit the inferred intent to Platform 420. In some embodiments, Platform 420 may fetch from Workflows 440 respective workflow based on inferred intent and entities. Workflows 440 may be configured to hold workflows for each inferred intent and entity combination. These workflows may hold details of which Digital Assistant Handler API 460 to invoke when a specific intent is inferred by NLU Service 430.

In some embodiments, Digital Assistant Handler API 460 is triggered with application context fetched from the customer and inferred details from NLU Service 430. Digital Assistant Handler API 460 may make a call to Glass Orchestration Layer 470 to get check and get items ordered that have been previously ordered (e.g., items ordered in a predetermined time period). Using the example above, Digital Assistant Handler API 460 may make a call to Glass Orchestration Layer 470 to get check and get “apples” ordered that have been ordered by the user in the past six months. Glass Orchestration Layer 470 may return an item ID (e.g., usitemid) of items that were ordered in the past (e.g., apples that were ordered by the customer in the past six months) to Digital Assistant Handler API 460. In some embodiments, Digital Assistant Handler API 460 calls Glass Orchestration Layer 470 to get details around the customer data related to Cart, Purchase History, in order to make decisions based on the data received and give near accurate results to customer. For example, if a customer says, “reorder bananas,” Digital Assistant Handler API 460 calls Glass Orchestration Layer 470 to get details of “bananas” customer has previously purchased.

Digital Assistant Handler API 460 may send the item ID to Personalisation Service 480. Personalisation Service 480 may be configured to rank (or re-rank) the list of products bought by the customer and pins (e.g., apply a weight) the most relevant item on top based on explicit and implicit attributes. Personalisation Service 480 may rank item based on the number of times an item is bought and different purchase patterns. For example, if in the above example there are two bananas found in the purchase history for the customer, item IDs for these two bananas are transmitted to Personalisation Service 480, and Personalisation Service 480 will rearrange the products and pin most relevant product on top. In some embodiments, the relevant product will be selected and added to the customer's cart.

Personalisation Service 480 may return ranked item IDs to Digital Assistant Handler API 460. The ranked items may be ranked based on a various parameters, such as customer preferences determined by analyzer 102 using one or more models and historical transaction data of the customer.

In some embodiments, Digital Assistant Handler API 460 executes business logic based on data received by Glass Orchestration Layer 470, Personalisation Service 480, and application context (e.g., contextual data) to generate a deeplink and response to be sent to the customer. In some embodiments, business logic refers to matching linguistic data to customer data. The generated deeplink and response may be transmitted to Platform 420. In some embodiments, the generated deeplink is a webpage that is navigated to in response to the customer's query (e.g., prompt) and the response is the message transmitted to the customer. Platform 420 may transmit the generated deeplink and response to Adapter 410, which may curate the response received from Platform 420 to a format to be used by digital assistant 250. In some embodiments, based on the received response, analyzer 102 causes digital assistant 250 to display (via user interface 205) the desired item and/or task. Using the above example, based on the received response, analyzer 102 causes digital assistant 250 to display (via user interface 205) the “apples” that marked for “pickup.”

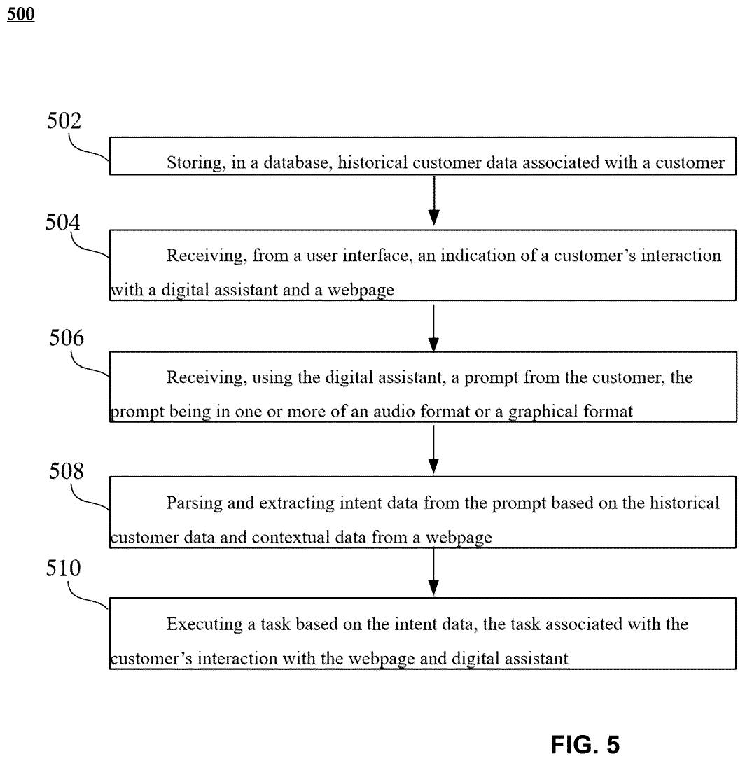

FIG. 5 is a flowchart illustrating an exemplary method for analyzing contextual data of a user interface. Although FIG. 5 references “apples” as the item being queried by the customer, any item may be used and queried by the customer. At operation 502, analyzer 102 stores historical customer data within database 116. Analyzer 102 may receive historical customer data from an electronic device or user interface associated with the customer. The historical customer data may include interaction data associated with the customer's interaction with an e-commerce platform of a retailer over a predetermined period of time. At operation 504, analyzer 102 may receive, from a user interface, an indication of a customer's interaction with a digital assistant and a webpage. The customer may interact with digital assistant 250 via user interface 205 while interacting with a webpage of a retailer. At operation 506, analyzer 102 may receive, using the digital assistant, a prompt from the customer, the prompt being in one or more of an audio format or a graphical format. Digital assistant 250 may receive an audio or graphical (e.g., text) input/prompt from a customer to perform a desired task. The prompt may be a desired task that the customer wishes to accomplish and may use digital assistant 250 and analyzer 102 to accomplish the task. Upon providing the prompt, analyzer 102 may perform the task without additional human innervation from the customer.

At operation 508, analyzer 102 may parse and extract intent data from the prompt based on the historical customer data and contextual data from a webpage. The intent data may be associated with an inferred intent of the customer based on the prompt provided. For example, analyzer 102 may parse prompt data (e.g., the prompt) and determined an inferred intent. The inferred item may be associated with a desired item and/or desired task of the customer. Analyzer 102 may extract an inferred intent based on the contextual data of the webpage that the customer is interacting with at the time the prompt is provided. The contextual data may provide additional information as to the desired task and/or desired item of the customer. The contextual data may allow analyzer 102 to perform a task without additional intervention by the customer. The intent data may include linguistic content and analyzer 102 may be configured execute a task based on historical customer data, contextual data from webpage, and business related operations. For example, analyzer 102 may allow a user to reorder items, add items to cart, and go to account services associated with that user. Analyzer 102, based on the intent data, may be configured to execute tasks based on the closest intent of the user/customer. In some embodiments, the intent data is based on the language model/the prompt itself. The response may be determined in part by the customer data and the contextual data. For example, the prompt of “reorder apples” may always be understood in the same manner. The type of apples is based on other data (e.g., customer historical data) and/or what the customer is looking at (e.g., contextual data). In some embodiments, historical customer data and contextual data from a webpage are used to determine how to execute a task associated with the customer's interaction (e.g., prompt).

At operation 510, analyzer 102 may execute a task based on the intent data, the task being associated with the customer's interaction with the webpage and the digital assistant. For example, analyzer 102 may determine/infer an intent of the customer based on the contextual data to add an item for a cart for purchase. Analyzer 102 may add the item to the cart for purchase and cause user interface 205 to display confirmation of the purchase and/or cause digital assistant 250 to provide a response to the customer associated with the purchase of the item.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing historical customer data associated with a customer;
a computing device comprising at least one processor in communication with the database, the computing device being configured to:
receive, from a user interface, an indication of a customer's interaction with a digital assistant and a webpage;
receive, using the digital assistant, a prompt from the customer, the prompt being in one or more of an audio format or a graphical format;
parse and extract intent data from the prompt based on the historical customer data and contextual data from the webpage; and
execute a task based on the intent data, the task associated with the customer's interaction with the webpage and the digital assistant.

2. The system of claim 1, wherein the historical customer data includes interaction data.

3. The system of claim 1, wherein the prompt from the customer includes an activation word.

4. The system of claim 1, wherein the intent data corresponds to a desired item or a desired task.

5. The system of claim 1, wherein the intent data includes linguistic data.

6. The system of claim 5, wherein the computing device is further configured to parse and extract intent data via a natural language processing model.

7. The system of claim 1, wherein the computing device is further configured to request, using the digital assistant, additional information from the customer, wherein the additional information is associated with the task.

8. The system of claim 7, wherein the computing device is further configured to:
receive, using the digital assistant, the additional information from the customer; and
parse and extract intent data from the additional information based on the historical customer data and contextual data from the webpage.

9. A method comprising:
storing, in a database, historical customer data associated with a customer;
receiving, from a user interface, an indication of a customer's interaction with a digital assistant and a webpage;
receiving, using the digital assistant, a prompt from the customer, the prompt being in one or more of an audio format or a graphical format;
parsing and extracting intent data from the prompt based on the historical customer data and contextual data from the webpage; and
executing a task based on the intent data, the task associated with the customer's interaction with the webpage and the digital assistant.

10. The method of claim 9, wherein the historical customer data includes interaction data.

11. The method of claim 9, wherein the prompt from the customer includes an activation word.

12. The method of claim 9, wherein the intent data corresponds to a desired item or a desired task.

13. The method of claim 9, wherein the intent data includes linguistic data.

14. The method of claim 13, further comprising parsing and extracting intent data via a natural language processing model.

15. The method of claim 9, further comprising requesting, using the digital assistant, additional information from the customer, wherein the additional information is associated with the task.

16. The method of claim 15, further comprising:
receiving, using the digital assistant, the additional information from the customer; and
parsing and extracting intent data from the additional information based on the historical customer data and contextual data from the webpage.

17. A non-transitory computer readable medium having instructions stored thereon, wherein the instructions, when executed by at least one processor, cause at least one device to perform operations comprising:
storing, in a database, historical customer data associated with a customer;
receiving, from a user interface, an indication of a customer's interaction with a digital assistant and a webpage;
receiving, using the digital assistant, a prompt from the customer, the prompt being in one or more of an audio format or a graphical format;
parsing and extracting intent data from the prompt based on the historical customer data and contextual data from the webpage; and
executing a task based on the intent data, the task associated with the customer's interaction with the webpage and the digital assistant.

18. The non-transitory computer readable medium of claim 17, wherein the historical customer data includes interaction data.

19. The non-transitory computer readable medium of claim 17, wherein the instructions cause at least one device to perform operations further comprising requesting, using the digital assistant, additional information from the customer, wherein the additional information is associated with the task.

20. The non-transitory computer readable medium of claim 19, wherein the instructions cause at least one device to perform operations further comprising:
receiving, using the digital assistant, the additional information from the customer; and
parsing and extracting intent data from the additional information based on the historical customer data and contextual data from the webpage.
